(19) United States
(12) Patent Application Publication
(10) Pub. No.: US 2002/0116338 A1
(43) Pub. Date: Aug. 22, 2002

(54) Prepaid access to internet protocol (IP) networks

(76) Inventors: Jean-Charles Gonthier, Montreal (CA); Miguel Cobo, Montreal (CA); John Barna, Beaconsfield (CA)

Correspondence Address: Andre M. Szuwalski, Jenkens & Gilchrist, P.C., 1445 Ross Avenue, Suite 3200, Dallas, TX, 75202-2799, US

(21) Appl. No.: 09/789,562

(22) Filed: Feb. 22, 2001

(51) Int. Cl. G06F 17/60

(52) U.S. Cl. 705/52

(57) ABSTRACT

The invention relates to a solution for prepaid access to an Internet Protocol (IP) network, and particularly a third generation (3G) network. A user has a prepaid account configured in his terminal and in a Prepaid Server (PPS). When the user wants to access the network, an access server requests that the PPS authenticates the terminal and, if accepted, responds with a message informing the access server of how much the terminal can utilise network resources before a re-authentication is necessary. When this limit is met, the access server re-requests authentication until the user disconnects or the account is exhausted, in which case the user is denied further access.

### BACKGROUND OF THE INVENTION

1. Technical Field of the Invention

The present invention relates to telecommunications systems, and in particular to prepaid solutions for access to IP networks.

2. Description of Related Art

Prepaid solutions allow a subscriber to pay for his usage of a system in advance. The subscriber has an account with a certain amount of credit. This credit is valid for a certain connection time, a certain amount of transferred information, access to certain services, or variations thereupon. Whenever the user uses the system and performs actions that will count toward his credit, the credit is decreased. If the user is only credited for transferred information, he may for example stay connected infinitely without being credited. Once the credit has been brought to zero, or a validity period for the credit has expired, the subscriber will no longer be able to use the credit to access the system until more credit has been added to the account.

Prepaid solutions already exist for present second-generation (2G) mobile telephony, where the user pays for a certain connection time, sometimes just for making calls, sometimes for making and receiving calls.

With the emergence of third-generation (3) wireless technologies that among other things provide easy access to Internet Protocol (IP) networks, the prepaid solutions for 2G systems are not sufficient. Today, access control in IP networks is provided via the Remote Authentication Dial in User Service (RADIUS) protocol or similar protocols, which is used for authentication of users and authorisation of network access. RADIUS (or other existing protocols) alone cannot provide prepaid functionality, as it cannot control the state of the user's session or disconnect him, for instance when the prepaid account is exhausted.

The RADIUS protocol has been used extensively in a proposal for a prepaid solution for 3G, “Pre-Paid for IS-835” 3GPP2/TSG-P-20000821-XX submitted to the Third Generation Partnership Project 2 (3GPP2). This proposal does however require the use of RADIUS accounting as well as RADIUS authorisation. This is unnecessarily limiting, especially as other ways of accounting may be used in an IP network.

The present invention seeks to overcome the limitations of the Prior Art in providing a method, a system, and network nodes that allow a generic prepaid solution for access to IP networks.

### SUMMARY OF THE INVENTION

The present invention is directed to a system for providing prepaid access to an Internet protocol (IP) network for a terminal using a prepaid account. The system comprises an access server, a prepaid server (PPS) storing account information associated with the terminal, and at least one connection to the IP network. The PPS is for receiving an access request from the access server and authenticating the account. If the account was successfully authenticated, the PPS sends an access accept message comprising attributes relating to the account's allowed network usage to the access server. The access server is for receiving an access accept message from the PPS, allowing the terminal to access to the IP network, and counting the account's network usage. When the usage reaches the limit given in the attributes, the access server interrupts the terminal's network access, and sends an access request to the PPS.

The present invention is further directed to a method for providing prepaid access to an Internet protocol (IP) network for a terminal using a prepaid account. The network comprises an access server, a prepaid server (PPS), and at least one connection to the IP network. The access server has a protocol client, the PPS has a corresponding protocol server, and the PPS also stores account information associated with the terminal. To grant access to the IP network, the protocol server in the PPS sends an access accept message comprising attributes relating to the account's allowed network usage to the protocol client in the access server. Upon reception of the access accept message, the access server allows the terminal to access the IP network and counts the account's network usage. When the usage reaches a limit given in the attributes, the access server interrupts the terminal's network access and sends an access request from the protocol client to the protocol server in the PPS.

The invention is further directed to an access server in a network for providing prepaid access for a terminal using a prepaid account to an Internet protocol (IP) network. The network further comprises a prepaid server (PPS) storing account information associated with the terminal, and at least one connection to the IP network. The access server comprises a first communication unit for receiving from the PPS an access accept message comprising at least one limit to the account's allowed resource usage, and sending an access request to the PPS. The access server further comprises a network access control unit for allowing the terminal to access to the IP network, counting the account's resource usage, and, when the usage reaches the at least one limit, interrupting the terminal's network access.

The invention is further directed to a prepaid server (PPS) in a network for providing prepaid access to an Internet protocol (IP) network for a terminal using a prepaid account, the network further comprising an access server, and at least one connection to the IP network. The PPS comprises a memory for storing account information associated with the terminal, an authentication unit for authenticating the account, and a communication unit for receiving an access request from the access server, and if the account was successfully authenticated, sending to the access server an access accept message comprising at least one limit to the account's allowed resource usage.

### BRIEF DESCRIPTION OF THE DRAWINGS

A more complete understanding of the present invention may be had by reference to the following Detailed Description when taken in conjunction with the accompanying drawings wherein:

FIG. 1 depicts a block diagram of a third generation wireless telecommunications network providing prepaid access according to the invention;

FIG. 2 depicts a signal flow chart illustrating the method for providing prepaid network access according to a preferred embodiment of the invention; and

FIG. 3 depicts block diagrams of preferred embodiments of two network nodes according to the invention.

### DETAILED DESCRIPTION OF EMBODIMENTS

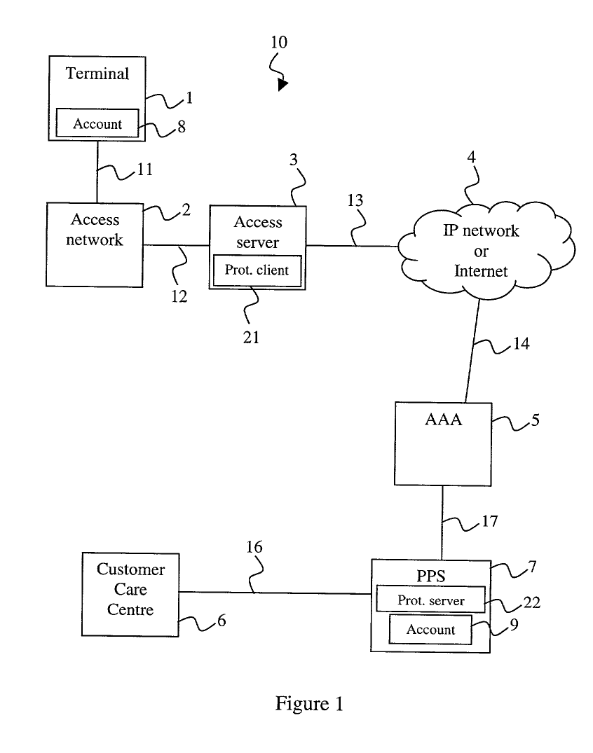

Reference is now made to the Drawings, where FIG. 1 depicts a block diagram of a third generation wireless telecommunications network 10 providing prepaid access. A user that desires to use the network 10 needs an Internet Protocol (IP) capable terminal 1, such as for example a Personal Computer (PC) or a 3G wireless phone, that is associated with an Internet prepaid account configured, by a Customer Care Centre (CCC) 6, in the terminal 1 and in a PrePaid Server (PPS) 7. Data regarding the prepaid account is distributed in the network 10. The terminal 1 (or a prepaid card in the terminal 1) stores terminal account data 8 that among other things comprises an account identifier, such as for example an account number. If the account is linked to the user, then the account identity could be the Network Access Identifier (NAI)—such as for example “usemame@realm” and a password—that uniquely identifies a user, although that user could allow someone else to access the network under his name. The PPS 7 stores PPS account data 9 that comprises the account identifier and an account status, such as for example the remaining amount of credit. The PPS account data 9 may also comprise information on the type of billing plan that is associated with the account, i.e. the criteria according to which the account is to be charged.

The user can access the network 10 with his terminal 1 via an air interface 11 providing a connection to an access network 2, such as for example General Packet Radio Service (GPRS), Universal Mobile Telecommunications System (UMTS), cdma2000™, and wireless Local Access Network (LAN). The user may also access the network 10 through a dial-up connection. The access network 2 has a connection 12 with an access server 3, and can be said to act as a go-between between the terminal 1 and the access server 3. This access server 3 may, depending on the system used, for example be:

a Network Access Server (NAS) for wireline connections,

a Packet Data Service Node (PDSN) for cdma2000™,

Gateway GPRS Serving/Support Node (GGSN) for General Packet Radio Service/Universal Mobile Telecommunications System GPRS/UMTS or

Interworking Function (IWF) for second generation (2G) systems.

The access server 3, that manages access to the network, has a protocol client 21 to support prepaid functionality. The protocol used may be suitably modified Remote Authentication Dial in User Service (RADIUS), Simple Network Management Protocol (SNMP), or any other suitable protocol, as long as the protocol adheres to a client-server model. Throughout this application, RADIUS will be used as an example, but it should be noted that other protocols could be used with the suitable changes made. It should also be noted that while in the examples given, it is the access server 3 that initiates the communication with the PPS 7 that in turn replies, it could also be the other way around. In that case, the PPS 7 regularly asks the access server 3 if it has any relevant messages upon which the access server 3 responds by sending its relevant messages.

The access server 3 has a connection 13 to an IP network or the Internet 4 (hereinafter referred to as the Internet 4), that in turn has a connection 14 to an Authentication, Authorisation and Accounting (AAA) framework 5 that is responsible for those functions in the network 10. The AAA framework 5 usually comprises several nodes. The AAA framework 5 has a further connection 17 to the PPS 7 that stores the PPS account data 9 and also comprises a protocol server 22, corresponding to the protocol client 21 in the access server 3. The PPS 7 further has a connection 16 to the Customer Care Centre (CCC) 6, through which the CCC 6 among other things may create and update PPS account data 9. In addition, the PPS 7 stores a list (not shown) of access servers that support the prepaid solution. The PPS 7 may, apart from being a standalone node, also reside within the AAA framework 5, such as for instance co-located with AAA functionality in a node in the AAA framework 5.

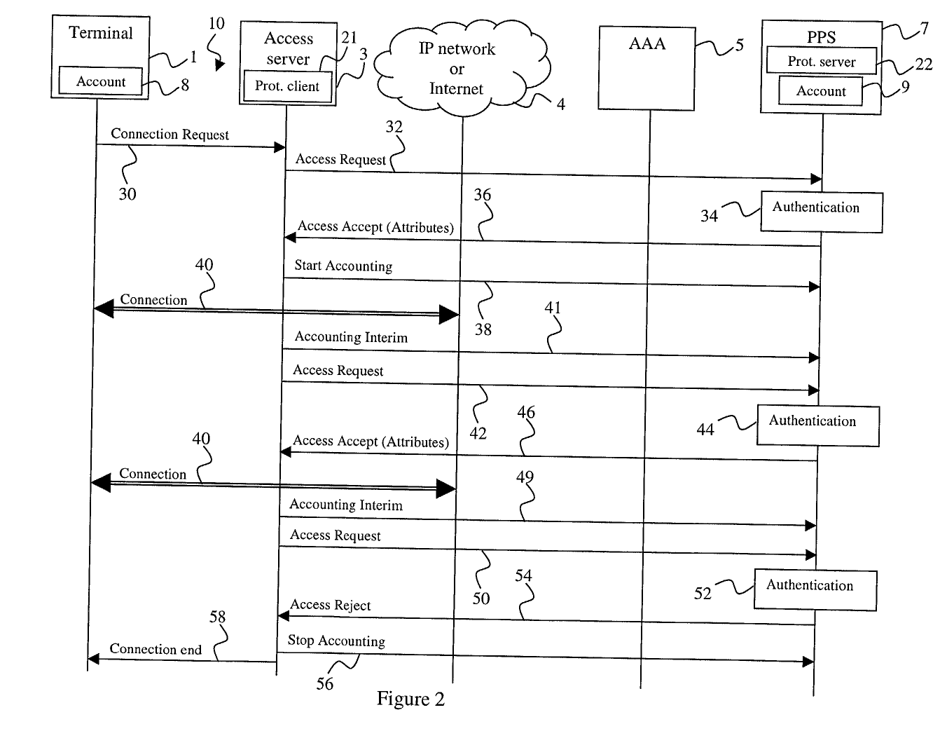

FIG. 2 depicts a signal flow chart illustrating the method according to a preferred embodiment of the invention. Using the reference numbers from FIG. 1 where applicable, FIG. 2 shows the network 10, a terminal 1 with terminal account data 8, an access server 3 with a protocol client 21, the Internet 4, a PrePaid Server (PPS) 7 with a protocol server 22 and PPS account information 9 corresponding to the terminal account data 8, and an Authentication, Authorisation and Accounting (AAA) framework 5 (hereinafter AAA 5).

When the user wants to access the network 10, for example in order to retrieve information from the Internet 4, he activates his terminal 1 that sends to the access server 3 a connection request message 30 comprising the account identifier. The protocol client 21 residing in the access server 3 sends an Access Request message 32, comprising the account information received from the terminal 1, to the protocol server 22 residing in the PPS 7. The Access Request message 32, like all messages between the access server 3 and the PPS 7, is sent via the AAA 5 that proxies the messages and may also consult the information in the messages before sending them to the destination. The PPS 7 then authenticates the account using the account information received from the access server 3 and the PPS account information 9, and checks if the access server 3 is on the list (not shown) of access servers that support the prepaid solution; step 34. If the account has enough credit, then the protocol server 22 sends an Access Accept message 36 comprising the necessary standard information to allow access and at least one attribute specific to prepaid accounts. These prepaid specific attributes may for example be:

the amount of time the user is allowed to be connected before re-authentication should be made,

the amount of data the user is allowed to receive before re-authentication should be made,

the amount of data the user is allowed to send before re-authentication should be made, and

the total amount of data the user is allowed to send and receive before re-authentication should be made.

Other attributes that may be included are:

a unique identifier associated with the account for the present session; the identifier is used in all subsequent messages to identify the account,

the allowed or forbidden destination address or IP number,

the allowed or forbidden port number, and

the allowed or forbidden transportation protocol

If the network 10 for example allows RADIUS accounting, then at least one of the following attributes must be added to the Access Accept message 36:

the amount of time the user is allowed to be connected before an accounting-interim message should be sent,

the amount of data the user is allowed to receive before an accounting-interim message should be sent,

the amount of data the user is allowed to send before an accounting-interim message should be sent, and

the total amount of data the user is allowed to send and receive before an accounting-interim message should be sent.

Upon reception of the Access Accept message 36, the access server 3 may then send a Start Accounting message 38, such as a RADIUS Accounting Request Start, to the PPS 7, thereby notifying the PPS 7 that accounting should start for the account. In some implementations, the access server 3 will retransmit a message until it receives an acknowledgement. The access server 3 also sets up a connection 40 between the terminal 1 and for example the Internet 4, via the access server 3. As the user utilises system resources, the access server 3 counts the utilisation according to the attributes received in the Access Accept message 36, i.e. the access server 3 counts for example connection time, amount of received or transmitted data, amount of received and transmitted data, or a combination of two or more attributes.

Whenever the access server 3 has counted that the utilisation of resources has reached its allowed limit, the protocol client sends a new (second) Access Request message 42 to protocol server 22 in the PPS 7, and may temporarily suspend further network access. Prior to the new (second) Access Request message 42, the access server 3 may send one or more Accounting Interim messages 41, such as RADIUS Accounting Interim, to the PPS 7. An Accounting Interim message informs the PPS 7 of the present state of account usage and the like. Upon reception of information about the account's resource usage, such as for example through an Accounting Interim message, the PPS 7 may update the account information 9 it has stored.

Upon reception of the Access Request message 42, the PPS 7 then authenticates the terminal, action 44, and, if the terminal is authenticated, responds with a (second) Access Accept message 46 comprising attributes as described hereinbefore. These attributes may be different from the ones sent in the previous Access Accept message 36. This may be the case if the PPS 7 decides to allow a different amount of system usage, such as for example if the account does not have much credit left, or for example if the amount of system usage is counted cumulatively. The access server 3 then lets the terminal 1 continue with the connection 40 to the Internet 4, counts system usage and, when appropriate, may send at least one Accounting Interim message 49 to the PPS 7, and has the protocol client 21 send a new (third) Access Request message 50 to the protocol server 22 in the PPS 7 that once again authenticates the terminal 1, action 52.

Assuming that the account is now exhausted, the protocol server 22 sends an Access Reject message 54 to the protocol client 21, whereupon the access server 3 denies the terminal 1 further access to the system resources, or at least such access that counts toward the credit of the account. The terminal 1 may in any case be given access to certain specific services, such as for example emergency numbers and numbers for increasing account credit. The access server 3 may also send a Stop Accounting message 56, such as an Accounting Request Stop, to the PPS 7, informing the PPS 7 that the terminal 1 corresponding to the account is no longer using system resources, at least not any resources that lead to changes in the account credit, and informs the PPS 7 about the account's recent system utilisation. The access server 3 may also send a message 58 to the terminal 1 indicating that access to, at least certain, system resources is denied due to a lack of credit, and possibly disconnecting the connection between the terminal 1 and the access server 3.

The PPS 7 (and the AAA 5) may use many different ways to handle the accounting, such as for example RADIUS, SNMP or direct information from various service nodes. An example of the latter is prepaid emails, in which case the user might be allowed to send a certain number of emails, a number that would be reduced by the PPS 7 every time an email is sent or possibly received.

A user may at any time increase the credit of an account by for example contacting the Customer Care Centre 6 through, for instance, a service number or by accessing a Web page.

It is also possible to have more that one user share the same account that for example may allow 200 minutes of system access for all of them taken together, i.e. the average allowed system access would be the allowed time divided by the number of users. There is also a possibility, however, to allow more than one user, with a possible limit to the number of users, to access the system at the same time, while still only charging for utilisation corresponding to one user or some other rate of charging, such as for example “three for the price of two” or “never charge for more than four simultaneous users”. When the account credit is exhausted, all the terminals using the account are denied further system access until the credit is increased or until they change to a valid account with remaining credit.

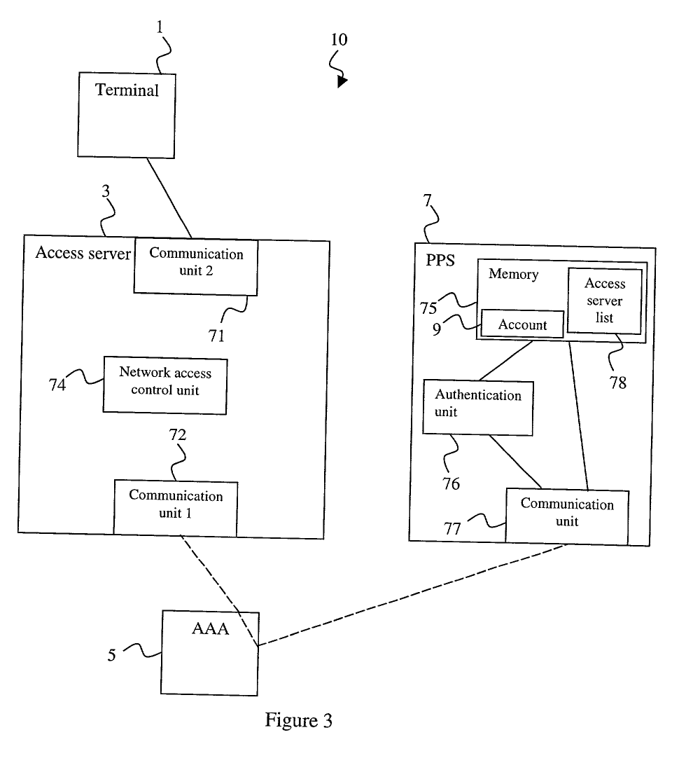

FIG. 3 depicts block diagrams of preferred embodiments of two network nodes according to the invention. Using the reference numbers from previous figures where applicable, FIG. 3 shows a network 10 comprising a terminal 1, an access server 3, a PrePaid Server (PPS) 7 and an Authentication, Authorisation and Accounting (AAA) framework 5 (hereinafter AAA 5). The access server 3 has connections to the terminal 1, the AAA 5 and the PPS 7.

The access server 3 has a first connection unit 72 for communication with the PPS 7 through the AAA 5 (indicated by the dashed line), and a second communication unit 71 for communication with the terminal 1. The first communication unit 72 may in some embodiments be, or comprise, a protocol client, as described hereinbefore. The access server 3 further comprises a network access control unit 74 that controls the terminal's network access by allowing access, interrupting access and counting the terminal's system or resource usage, as described hereinbefore.

The PPS 7 comprises a communication unit 77 for communication with the access server 3 through the AAA 5. As this communication unit 77 corresponds to the first communication unit 72 in the access server 3, this communication unit 77 may also be, or comprise, a protocol server corresponding to the protocol client in the access server 3. The PPS 7 further comprises an authentication unit 76 for authenticating prepaid accounts, and a memory 75 for storing account information 9 and an access server list 78 detailing the access servers that support the prepaid solution. The authentication unit 76 is also for updating account information 9 stored in the memory 75, for example upon reception of information about the account's resource usage, as for example received in an accounting Interim message.

The messages sent between the access server 3 and the PPS 7 through the AAA 5 may be simply forwarded to the destination by the AAA 5, but the AAA 5 may also read the messages. The latter may be of use for, as an example, gathering information about what is happening in the network.

It can be appreciated by a person skilled in the art that the solution for prepaid access as described hereinbefore is flexible in that it is independent of both protocols and accounting system.

Only the network parts necessary for the understanding of the invention is shown in the figures and described hereinbefore, but a person skilled in the art will appreciate that other network parts will normally exist in a real network.

Although several preferred embodiments of the methods, systems and nodes of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A system for providing prepaid access for a terminal using a prepaid account to an Internet protocol (IP) network, the system comprising an access server, a prepaid server (PPS), and at least one connection to the IP network, wherein the PPS stores account information associated with the terminal, and wherein:
the PPS is for:
receiving an access request from the access server;
authenticating the account; and if the account was successfully authenticated
sending to the access server an access accept message comprising at least one limit to the account's allowed resource usage; and
the access server is for:
receiving an access accept message from the PPS;
allowing the terminal to access to the IP network; and
counting the account's resource usage, and when the usage reaches the limit:
interrupting the terminal's network access; and
sending an access request to the PPS.

2. The system according to claim 1, wherein the access server further is for, previous to receiving an access accept message from the PPS, sending a first access request to the PPS, the first access request comprising the account identity of the prepaid account used by the terminal.

3. The system according to claim 2, wherein the access server further is for receiving a connection request from the terminal.

4. The system according to claim 3, wherein the connection request comprises the account identity of the prepaid account used by the terminal.

5. The system according to claim 1, wherein the access server comprises a protocol client and the PPS comprises a corresponding protocol server.

6. The system according to claim 5, wherein the messages between the access server and the PPS are sent between the protocol client and the protocol server.

7. The system according to claim 5, wherein the protocol used by the protocol client and the protocol server adheres to a client-server model.

8. The system according to claim 7, wherein the protocol is Remote Authentication Dial In User Service (RADIUS).

9. The system according to claim 1, wherein the PPS sends an access reject message to the access server in case the account was not authenticated.

10. The system according to claim 9, wherein the access server disconnects the terminal upon reception of the access reject message.

11. The system according to claim 1 further comprising an Authentication, Authorisation and Accounting (AAA) framework through which the PPS and the access server communicate.

12. The system according to claim 1, wherein the access server sends a start accounting message to the PPS upon reception of a first access accept message for a certain session for a certain account.

13. The system according to claim 1, wherein the access server sends at least one accounting interim message to the PPS after having received an access accept message and before sending an access request message.

14. The system according to claim 1, wherein the PPS is further for verifying that the access server supports the prepaid solution provided by the system.

15. In a network, a method for providing prepaid access for a terminal using a prepaid account to an Internet protocol (IP) network, the network comprising an access server, a prepaid server (PPS), and at least one connection to the IP network, the PPS storing account information associated with the terminal, the method comprising the steps of:
sending from the PPS to the access server an access accept message comprising at least one limit to the account's allowed resource usage; and
upon reception of the access accept message by the access server:
allowing the terminal to access the IP network; and
counting the account's resource usage; and when the usage reaches the limit:
interrupting the terminal's network access; and
sending an access request to the PPS.

16. The method according to claim 15, wherein step of sending an access accept message is preceded by the step of authenticating the account and the step of sending an access accept message is performed only if the account is successfully authenticated.

17. The method according to claim 16, wherein the step of authenticating the account is preceded by the step of sending a first access request from the access server to the PPS, the first access request comprising the account identity of the prepaid account used by the terminal.

18. The method according to claim 17, wherein the step of sending a first access request from the access server to the PPS is preceded by the steps of:
sending a connection request from the terminal; and
receiving the connection request at the access server.

19. The method according to claim 18, wherein the connection request comprises the account identity of the prepaid account used by the terminal.

20. The method according to claim 15, wherein the access server comprises a protocol client and the PPS comprises a corresponding protocol server.

21. The method according to claim 20, wherein the protocol used by the protocol server and the protocol client adheres to a client-server model.

22. The method according to claim 21, wherein the protocol is Remote Authentication Dial In User Service (RADIUS).

23. The method according to claim 16, wherein the PPS sends an access reject message to the access server in case the account did not pass the authentication.

24. The method according to claim 23, wherein the access server disconnects the terminal upon reception of the access reject message.

25. The method according to claim 15, wherein the network further comprises an Authentication, Authorisation and Accounting (AAA) framework through which the PPS and the access server communicate.

26. The method according to claim 15, wherein the access server sends a start accounting message to the PPS upon reception of a first access accept message for a certain session for a certain account.

27. The method according to claim 15, wherein the access server sends at least one accounting interim message to the PPS after having received an access accept message and before sending an access request message.

28. The method according to claim 16, wherein the step of authenticating the account further comprises the step of verifying that the access server supports the prepaid solution provided by the method.

29. An access server in a network for providing prepaid access for a terminal using a prepaid account to an Internet protocol (IP) network, the network further comprising a prepaid server (PPS), and at least one connection to the IP network, wherein the PPS stores account information associated with the terminal, and wherein the access server comprises:
a first communication unit for:
receiving from the PPS an access accept message comprising at least one limit to the account's allowed resource usage; and
sending an access request to the PPS; and
a network access control unit for:
allowing the terminal to access to the IP network;
counting the account's resource usage; and when the usage reaches the at least one limit:
interrupting the terminal's network access.

30. The access server according to claim 29, wherein the first communication unit further is for, previous to receiving an access accept message from the PPS, sending a first access request to the PPS, the first access request comprising the account identity of the prepaid account used by the terminal.

31. The access server according to claim 29, further comprising a second communication unit for receiving a connection request from the terminal.

32. The access server according to claim 31, wherein the connection request comprises the account identity of the prepaid account used by the terminal.

33. The access server according to claim 29, wherein the first communication unit is a protocol client corresponding to a protocol server in the PPS.

34. The access server according to claim 33, wherein the protocol used by the protocol client and the protocol server adheres to a client-server model.

35. The access server according to claim 34, wherein the protocol is Remote Authentication Dial In User Service (RADIUS).

36. The access server according to claim 29, wherein the network further comprises an Authentication, Authorisation and Accounting (AAA) framework and wherein the messages sent between the first communication unit and the PPS are sent through the AAA framework.

37. The access server according to claim 29, wherein the first communication unit further is for sending a start accounting message to the PPS upon reception of a first access accept message for a certain session for a certain account.

38. The access server according to claim 29, wherein the first communication unit further is for sending at least one accounting interim message to the PPS after having received an access accept message and before sending an access request message.

39. A prepaid server (PPS) in a network for providing prepaid access to an Internet protocol (IP) network for a terminal using a prepaid account, the network further comprising an access server, and at least one connection to the IP network, and wherein the PPS comprises:
a memory for storing account information associated with the terminal;
an authentication unit for authenticating the account; and
a communication unit for:
receiving an access request from the access server; and
if the account was successfully authenticated, sending to the access server an access accept message comprising at least one limit to the account's allowed resource usage.

40. The prepaid server (PPS) according to claim 39, wherein a first access request message associated with a terminal comprises the account identity of the prepaid account used by the terminal.

41. The prepaid server (PPS) according to claim 39, wherein the communication unit is a protocol server corresponding to a protocol client in the access server.

42. The prepaid server (PPS) according to claim 41, wherein the protocol used by the protocol client and the protocol server adheres to a client-server model.

43. The prepaid server (PPS) according to claim 42, wherein the protocol is Remote Authentication Dial In User Service (RADIUS).

44. The prepaid server (PPS) according to claim 39, wherein the communication unit further is for sending an access reject message to the access server in case the account was not successfully authenticated.

45. The prepaid server (PPS) according to claim 39, wherein the memory further is for storing a list of access servers that support the prepaid solution offered by the PPS, and the authentication unit further is for verifying that the access server that sent the access request is on the list of access servers.

46. The prepaid server (PPS) according to claim 39, wherein the communication unit further is for receiving from the access server information about the account's resource usage.

47. The prepaid server (PPS) according to claim 40, wherein the authentication unit further is for updating account information stored in the memory upon reception of the information about the account's resource usage.
